(19) United States
(12) Patent Application Publication
(10) Pub. No.: US 2010/0164672 A1
(43) Pub. Date: Jul. 1, 2010

(54) SEMICONDUCTOR DEVICE AND METHOD FOR MANUFACTURING THE SAME

(76) Inventor: Yeong-Joo Moon, Cheongju-si (KR)

Correspondence Address: SHERR & VAUGHN, PLLC, 620 HERNDON PARKWAY, SUITE 320, HERNDON, VA, 20170, US

(21) Appl. No.: 12/647,510

(22) Filed: Dec. 27, 2009

(30) Foreign Application Priority Data
Dec. 30, 2008 (KR) 10-2008-0137256

(51) Int. Cl. H01F 5/00

(52) U.S. Cl. 336/200

(57) ABSTRACT

A semiconductor device and a method for manufacturing the same improves performance of an inductor, wherein a PGS pattern formed in a spiral shape, like inductors, blocks electric current induced to a semiconductor substrate, removes effects of parasitic capacitance thereon and thereby improves performance of the inductor. In accordance with the method, the PGS pattern is formed in a spiral shape, like the inductor, to inhibit flow of induced current. As a result, flow of current induced to the semiconductor substrate, one of resistant conductors, can be blocked. In addition, the PGS pattern acts between the inductor and the semiconductor substrate, thus preventing current leakage to the semiconductor substrate. Furthermore, the PGS pattern is interposed between the inductor and the semiconductor substrate to form an inductor-inserted structure, thus enabling reduction in effects of parasitic capacitance generated between the inductor and the semiconductor substrate on the semiconductor substrate arranged thereunder.

The present application claims priority under 35 U.S.C. 119 to Korean Patent Application No. 10-2008-0137256 (filed on Dec. 30, 2008), which is hereby incorporated by reference in its entirety.

### BACKGROUND

Among semiconductor devices, passive devices include an inductor. To realize inductance on a semiconductor substrate, metal lines are formed in a spiral shape.

FIG. 1 is a view illustrating the structure of a spiral inductor, a direction in which current flows to the inductor and a direction in which current is induced in a semiconductor substrate according to the related art. As shown in FIG. 1, a metal line having a rectangle-like spiral structure shape may be formed on the semiconductor substrate to realize a spiral inductor 2.

When the spiral inductor 2 operates at a super-high frequency, magnetic flux is created around the inductor, which leads to formation of an induced current on the semiconductor substrate 1. As shown in FIG. 1, the induced current formed on the semiconductor substrate 1 flows opposite to a direction in which current flows through the inductor and thus inhibits current flow through the inductor. This causes a decrease in quality of an inductor and thus deterioration in inductor characteristics.

To prevent deterioration of inductor characteristics, attempts to increase resistance of semiconductor substrates and thereby limit current flow have been made in the related art. However, the resistance increase in semiconductor substrates inevitably entails use of high-resistance substrates, thus disadvantageously increasing manufacturing costs.

In another attempt, as shown in FIG. 2, a patterned ground shield (PGS) pattern 3 is formed on a semiconductor substrate or a metal layer arranged thereunder to artificially prevent current flow. FIG. 2 is a plan view illustrating a spiral inductor and a PGS pattern according to the related art. FIG. 3 is a view illustrating a direction (A) in which current flows through the spiral inductor and a direction (B) in which current is induced to the PGS pattern according to the related art, which shows inhibition of flow of the induced current using the PGS pattern 3 of FIG. 2.

As shown in FIG. 3, the PGS pattern 3 allows the charge passage (B) to be formed vertically to an induced current flow (A). The PGS pattern 3 serves to practically inhibit charge flow.

Meanwhile, the PGS pattern 3 should be connected to ground so that it more efficiently inhibits current flow. The PGS pattern 3 has no practical current passage B and thus cannot exert the desired function at all, when it is not connected to ground.

In addition, the PGS pattern 3 connected to ground can advantageously block induced current and reduce its effects on the semiconductor substrate. However, an increase in thickness of the film layer for the ground is inevitable, which disadvantageously leads to an increase in parasitic capacitance between the inductor 2 and the semiconductor substrate 1.

### SUMMARY

Embodiments relate to a semiconductor technology. More specifically, embodiments relate to a semiconductor device and a method for manufacturing the same to improve performance of inductors. Embodiments relate to a semiconductor device and a method for manufacturing the same, wherein a PGS pattern formed in a spiral shape, like inductors, blocks electric current induced to a semiconductor substrate, removes effects of parasitic capacitance thereon and thereby improves performance of the inductor.

Embodiments relate to a semiconductor device which may include: a spiral patterned ground shield provided in an insulating film over a semiconductor substrate; and a spiral inductor arranged over the insulating film in the same position as the patterned ground shield. The PGS pattern may spiral opposite to a spiral rotation direction of the inductor. Both ends of the PGS pattern may be connected to ground.

The PGS pattern may include a first line pattern which spirals from one side periphery to the center, and a second line pattern which spirals from the center to the other side periphery. The PGS pattern may have a closed-loop shape wherein the one end of the first line pattern arranged on the center is connected to one end of the second line pattern arranged on the center, and the other end of the first line pattern arranged in one side periphery is connected through an additional line pattern to the other end of the second line pattern arranged in the other side periphery.

The PGS pattern may have a structure wherein the one end of the first line pattern arranged on the center is separated from one end of the second line pattern arranged on the center, wherein the PSG pattern includes a first closed-loop provided by one additional line pattern to connect one end of the first line pattern arranged on the center to the other end of the first line pattern arranged on one side periphery, and a second closed-loop provided by another additional line pattern to connect one end of the second line pattern arranged on the center to the other end of the second line pattern arranged in the other side periphery.

Embodiments relate to a method for manufacturing a semiconductor device, including: forming a spiral patterned ground shield (PGS) pattern in an insulating film over a semiconductor substrate; and forming a spiral inductor over the insulating film in the same position as the PGS pattern.

The formation of the PSG pattern may include: forming a first line pattern spirally rotating from one side periphery to the center, and a second line pattern which spirals from the center to the other side periphery, such that one end of the first line pattern arranged on the center is connected to one end of the second line pattern arranged on the center.

The method may further include: forming an additional line pattern to connect the other end of the first line pattern arranged in one side periphery to the other end of the second line pattern arranged in the other side periphery. The formation of the PSG pattern may be carried out by forming a first line pattern which spirals from one side periphery to the center, and a second line pattern which spirals from the center to the other side periphery, such that one end of the first line pattern arranged on the center is separated from one end of the second line pattern arranged on the center.

The method may further include: forming one additional line pattern to connect one end of the first line pattern arranged on the center to the other end of the first line pattern arranged on one side periphery, and another additional line pattern to connect one end of the second line pattern arranged in the center to the other end of the second line pattern arranged in the other side periphery.

### DRAWINGS

FIG. 1 is a view illustrating the structure of a spiral inductor, a direction in which current flows to the inductor and a direction in which current is induced to a semiconductor substrate according to the related art.

FIG. 2 is a plan view illustrating a spiral inductor and a PGS pattern according to the related art.

FIG. 3 is a view illustrating a direction (A) in which current flows through the spiral inductor and a direction (B) in which the current is induced to the PGS pattern according to the related art, which shows inhibition of flow of the induced current using the PGS pattern 3 of FIG. 2.

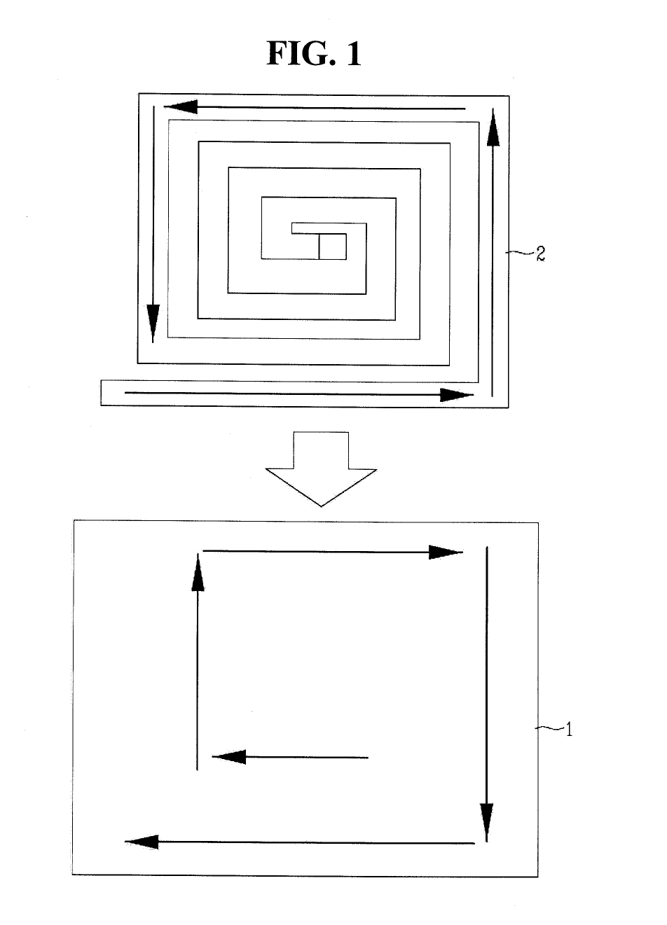

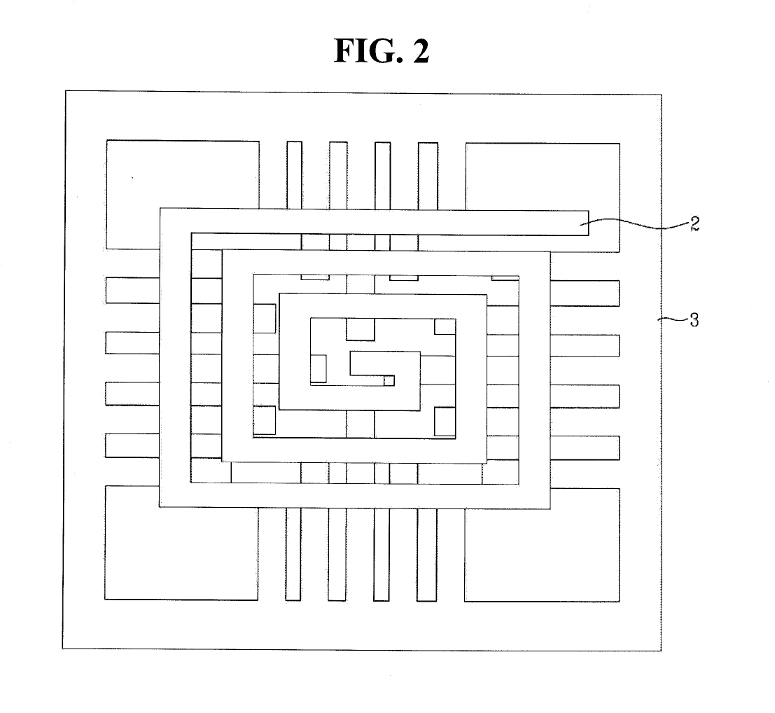

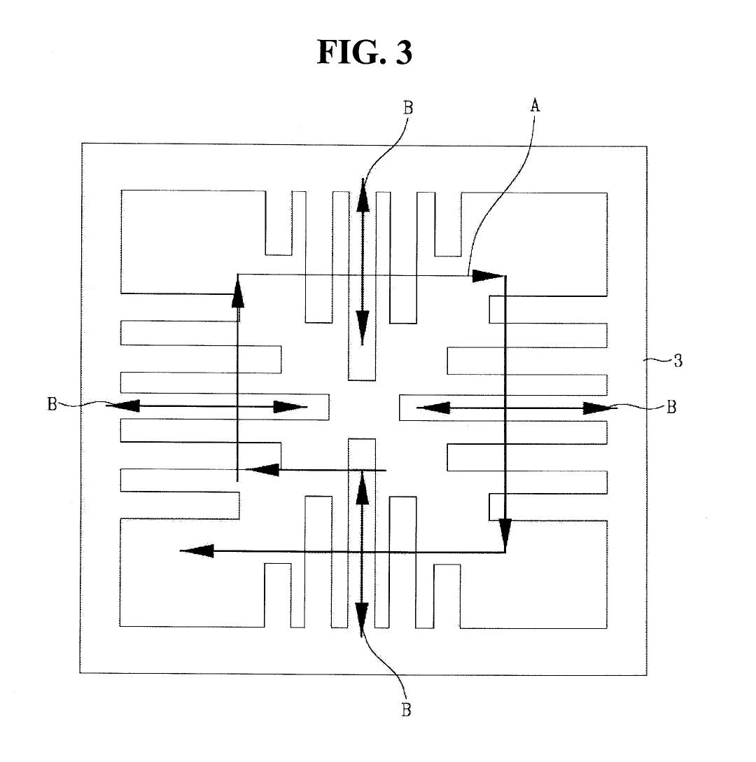

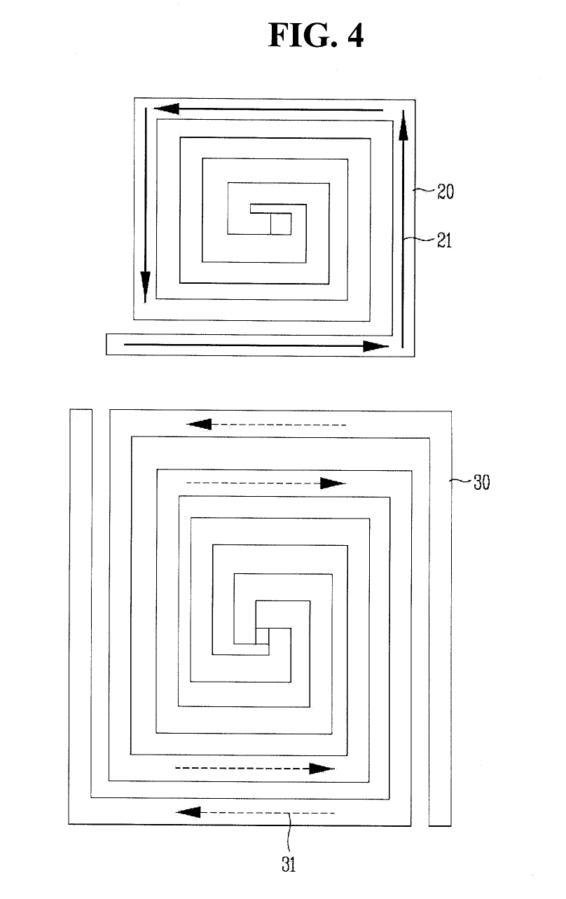

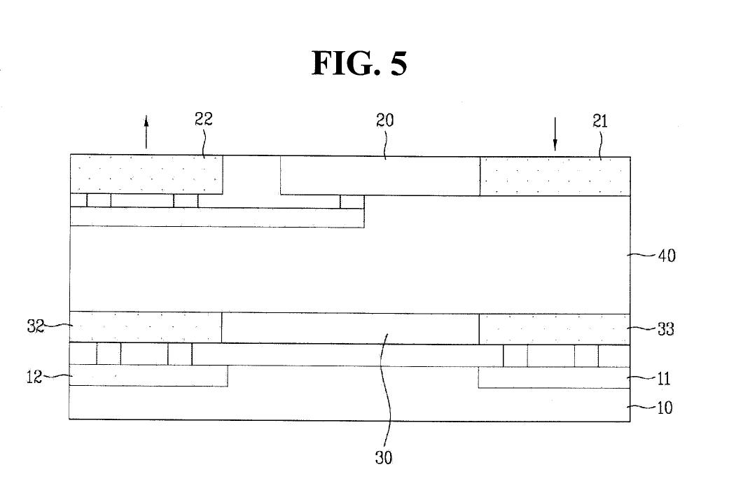

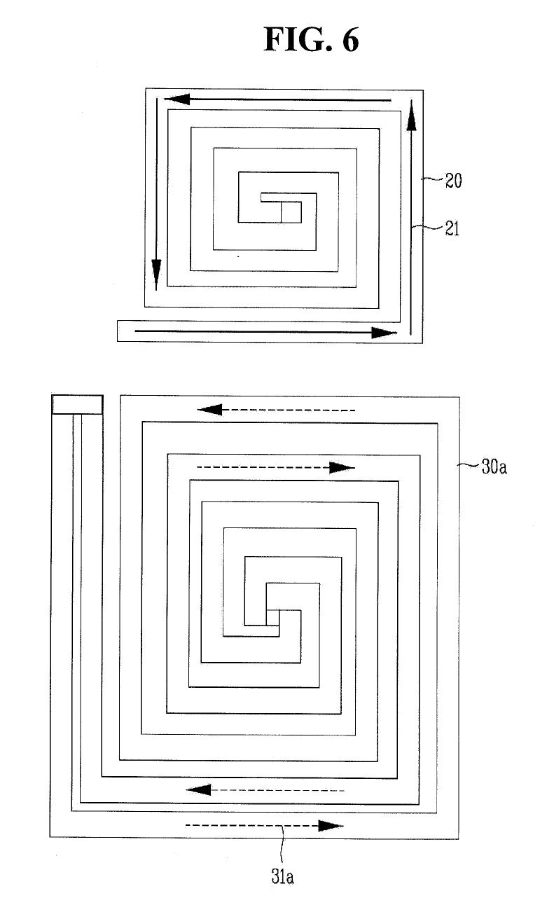

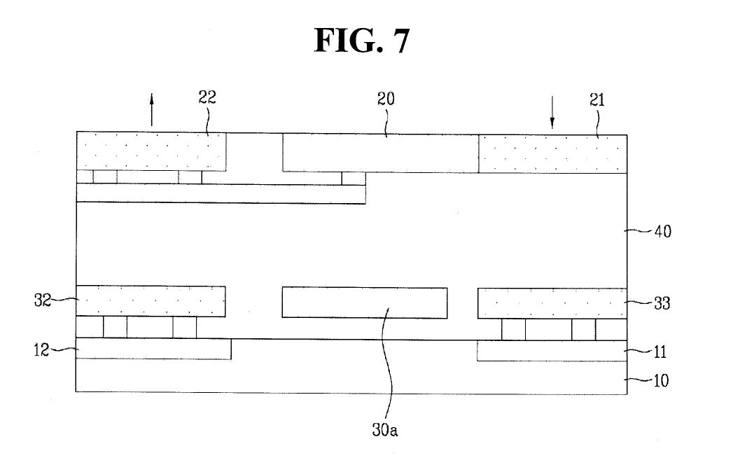

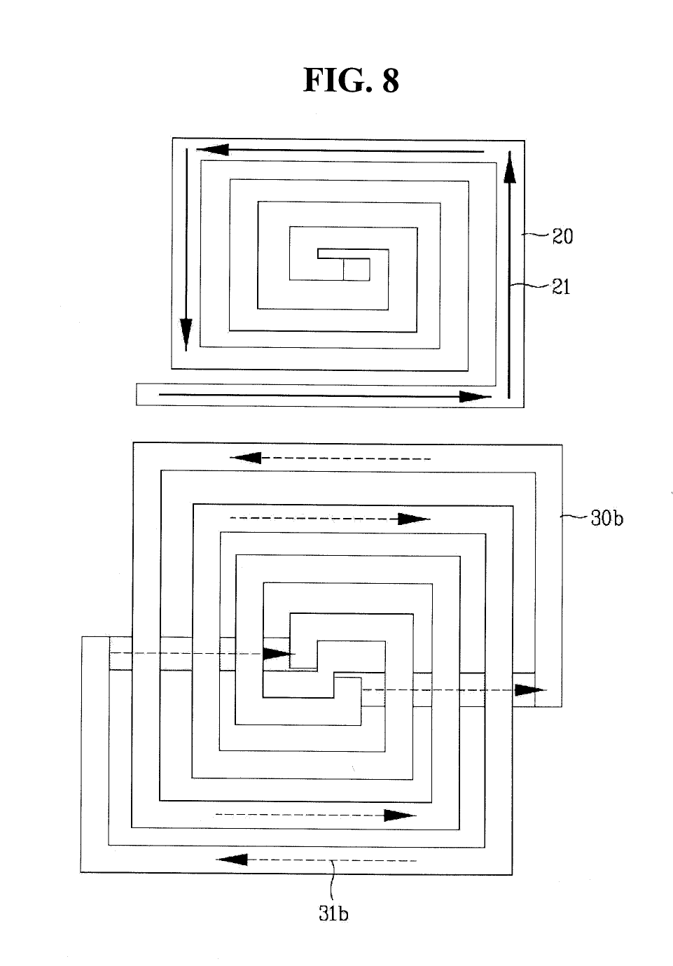

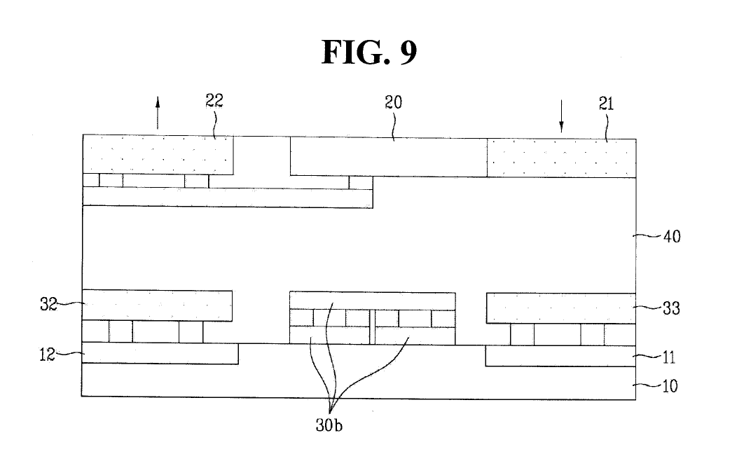

Example FIG. 4 is a view illustrating a spiral inductor structure and a PGS pattern, and a direction of current flowing through the spiral inductor and a direction of current induced to the PGS pattern, according to embodiments.

Example FIG. 5 is a sectional view illustrating the structure of the semiconductor device including the spiral inductor and the PGS pattern of example FIG. 4.

Example FIG. 6 is a view illustrating a spiral inductor structure and a PGS pattern, and a direction of current flowing through the spiral inductor and a direction of current induced to the PGS pattern, according to embodiments.

Example FIG. 7 is a sectional view illustrating the structure of the semiconductor device including the spiral inductor and the PGS pattern of example FIG. 6.

Example FIG. 8 is a view illustrating a spiral inductor structure and a PGS pattern, and a direction of current flowing through the spiral inductor and a direction of current induced to the PGS pattern, according to embodiments.

Example FIG. 9 is a sectional view illustrating the structure of the semiconductor device including the spiral inductor and the PGS pattern of example FIG. 8.

### DESCRIPTION

Hereinafter, a semiconductor device and a method for manufacturing the same according to embodiments will be illustrated with reference to the annexed drawings in detail. In accordance with embodiments, a PGS pattern may be formed as a spiral inductor, to block flow of current induced to a semiconductor substrate.

In particular, the semiconductor device according to embodiments comprises a spiral inductor and a spiral PGS pattern, wherein an insulating film is interposed therebetween. The PGS pattern is provided in an insulating film arranged over the semiconductor substrate and the inductor is provided over the insulating film in a position corresponding to the PGS pattern. For example, the PGS pattern may be spirally rotated opposite to a spiral rotation direction of the inductor. In this case, both ends of the PGS pattern are connected to ground.

Hereinafter, examples wherein the PGS pattern is not spirally rotated opposite to the spiral rotation direction of the inductor will be described with reference to example FIGS. 4 to 9. Example FIG. 4 is a view illustrating a spiral inductor structure and a PGS pattern, and a direction of current flowing through the spiral inductor and a direction of current induced to the PGS pattern, according to embodiments.

As shown in example FIG. 4, the PGS pattern 30 may include a first line pattern which spirally rotates from one side periphery to the center, and a second line pattern which spirally rotates from the center to the other side periphery. The one end of the first line pattern arranged on the center is connected to one end of the second line pattern arranged on the center. Both ends of the PGS pattern 30, i.e., the other end of the first line pattern arranged in one side periphery, and the other end of the second line pattern arranged in the other side periphery, are connected to ground.

The PGS pattern 30 may have a spiral shape. Accordingly, the PGS pattern 30 may be formed in a spiral pattern and thus includes lines having similar shapes in several portions. Accordingly, in the case where a current flow direction 21 of the spiral inductor 20 is counterclockwise, directions of currents (represented by reference numeral “31”) induced between lines adjacent to the PGS pattern are opposite to each other, and thus intervene in each other's induced current flow. As a result, flow of induced current is inhibited.

Example FIG. 5 is a sectional view illustrating the structure of the semiconductor device including the spiral inductor and the PGS pattern of example FIG. 4. Referring to example FIG. 5, ion-implanted regions 11 and 12, where impurity ions are implanted, may be formed over the semiconductor substrate 10. Terminals 32 and 33 connected to the PGS pattern 30 may be formed over the ion-implanted regions 11 and 12. Contact plugs to electrically connect the terminals 32 and 33 to the ion-implanted regions 11 and 12 may be formed thereon. Meanwhile, the terminals 32 and 33 may be ground terminals connected to the PGS pattern 30.

An insulating film 40 may be arranged over the semiconductor substrate 10. A spiral PGS pattern 30 may be formed in the insulating film 40 arranged over the semiconductor substrate 10. More specifically, the first line pattern which spirally rotates from one side periphery to the center, and the second line pattern which spirally rotates from the center to the other side periphery are formed. The first and second line patterns may be formed such that one end of the first line pattern arranged on the center is connected to one end of the second line pattern arranged on the center.

Subsequently, a spiral inductor 20 may be formed over the insulating film 40 at the same position as the PGS pattern 30 arranged thereunder. In addition, the terminals 21 and 22 connected to the spiral inductor 20 may be formed over the insulating film 40.

Example FIG. 6 is a view illustrating a spiral inductor structure and a PGS pattern, a direction of current flowing through the spiral inductor and a direction of current induced to the PGS pattern, according to embodiments. As shown in example FIG. 6, the PGS pattern 30a comprises a first line pattern which spirally rotates from one side periphery to the center, and a second line pattern which spirally rotates from the center to the other side periphery. The one end of the first line pattern arranged on the center is connected to one end of the second line pattern arranged on the center.

In example FIG. 6, the PGS pattern 30a includes an additional line pattern to form a closed-loop shape. The other end of the first line pattern arranged on one side periphery and the other end of the second line pattern arranged in the other periphery may be connected to each other through the additional line pattern to form a closed-loop.

The PGS pattern 30a is a closed-loop spiral. Accordingly, the PGS pattern 30a may be formed in a spiral shape and thus includes lines having similar shapes in several portions. Accordingly, in the case where a current flow direction 21 of the spiral inductor 20 is counterclockwise, directions of currents (represented by reference numeral “31a”) induced between lines adjacent to the PGS pattern 30a are opposite to each other and thus intervene in each other's induced current flow. As a result, flow of induced current is inhibited.

Example FIG. 7 is a sectional view illustrating the structure of the semiconductor device including the spiral inductor and the PGS pattern of example FIG. 6.

Referring to example FIG. 7, ion-implanted regions 11 and 12, where impurity ions are implanted, may be formed over the semiconductor substrate 10. Terminals 32 and 33 separated from the PGS pattern 30a may be formed over the ion-implanted regions 11 and 12. Contact plugs to electrically connect the terminals 32 and 33 to the ion-implanted regions 11 and 12 may be formed therebetween. Meanwhile, in the third embodiment, no ground terminal to connect the PSG pattern 30a is required, since the PSG pattern 30a forms a closed-loop.

An insulating film 40 may be arranged over the semiconductor substrate 10 and a closed-loop spiral PGS pattern 30a may be formed in the insulating film 40 arranged over the semiconductor substrate 10. More specifically, the first line pattern which may spirally rotate from one side periphery to the center, and the second line pattern which may spirally rotate from the center to the other side periphery are formed. The first and second line patterns may be formed such that one end of the first line pattern arranged on the center is connected to one end of the second line pattern arranged on the center. The PGS pattern 30a further may include an additional line pattern, to connect the other end of the first line pattern arranged in one side periphery to one end of the second line pattern arranged in the other side periphery. The PGS pattern 30a having a closed-loop shape may be formed by the additional line pattern.

Subsequently, a spiral inductor 20 may be formed over the insulating film 40 in the same position as the PGS pattern 30a arranged thereunder. In addition, the terminals 21 and 22 connected to the spiral inductor 20 may be formed over the insulating film 40.

Example FIG. 8 is a view illustrating a spiral inductor structure and a PGS pattern, and a direction of current flowing through the spiral inductor and a direction of current induced to the PGS pattern, according to embodiments. As shown in example FIG. 8, a PGS pattern 30b in this embodiment may include a first line pattern which spirally rotates from one side periphery to the center, and a second line pattern which spirally rotates from the center to the other side periphery. The one end of the first line pattern arranged on the center is not connected to and is separated from one end of the second line pattern arranged on the center.

In example FIG. 8, the PGS pattern 30b may further include a plurality of additional line patterns to form two closed-loops. The one end of the first line pattern arranged on the center is connected through one additional line pattern to the other end of the first line pattern arranged on one side periphery to form a first closed-loop, and one end of the second line pattern arranged in the center is connected to the other end of the second line pattern arranged in the other side periphery through another additional line pattern to form a second closed-loop.

In this embodiment, unlike the second embodiment, the PGS pattern 30b is formed to have two closed-loops. The PGS pattern 30b has a closed-loop spiral shape. Accordingly, the PGS pattern 30b may be formed in a spiral pattern and thus includes lines having similar shapes of several portions.

Accordingly, in the case where a current flow direction 21 of the spiral inductor 20 is counterclockwise, directions of currents (represented by reference numeral “31b”) induced between lines adjacent to the PGS pattern 30b are opposite to each other and thus intervene in each other's induced current flow. As a result, flow of induced current may be inhibited.

Example FIG. 9 is a sectional view illustrating the structure of the semiconductor device including the spiral inductor and the PGS pattern of example FIG. 8. Referring to example FIG. 9, ion-implanted regions 11 and 12, where impurity ions are implanted, may be formed over the semiconductor substrate 10. Terminals 32 and 33 separated from the PGS pattern 30b may be formed over the ion-implanted regions 11 and 12. Contact plugs to electrically connect the terminals 32 and 33 to the ion-implanted regions 11 and 12 may be formed therebetween. Meanwhile, in the embodiments illustrated in example FIG. 9, no ground terminal to connect the PSG pattern 30b is required, since the PSG pattern 30b forms two closed-loops. An insulating film 40 may be arranged over the semiconductor substrate 10. A closed-loop spiral PGS pattern 30b may be formed in the insulating film 40 arranged over the semiconductor substrate 10.

More specifically, the first line pattern which spirally rotates from one side periphery to the center and the second line pattern which spirally rotates from the center to the other side periphery may be formed. At this time, the one end of the first line pattern arranged on the center may be separated from one end of the second line pattern arranged on the center. There may be further formed one additional line pattern to connect one end of the first line pattern arranged on the center to one end of the first line pattern arranged on one side periphery, and another additional line pattern to connect one end of the second line pattern arranged in the center to the other end of the second line pattern arranged in the other side periphery. Two closed-loop shape of PGS patterns 30b may be formed by the two additional line patterns.

Subsequently, a spiral inductor 20 may be formed over the insulating film 40 in the same position as the PGS pattern 30 arranged thereunder. In addition, the terminals 21 and 22 connected to the spiral inductor 20 may be formed over the insulating film 40.

In accordance with embodiments, the PGS pattern may be formed in a spiral inductor to inhibit flow of induced current. As a result, flow of current induced to the semiconductor substrate, one of resistant conductors, can be blocked. In addition, the PGS pattern acts between the inductor and the semiconductor substrate, thus preventing current leakage to the semiconductor substrate. Also, the PGS pattern may be interposed between the inductor and the semiconductor substrate to form an inductor-inserted structure. Accordingly, such a structure enables reduction in effects of parasitic capacitance generated between the inductor and the semiconductor substrate on the semiconductor substrate arranged thereunder and thus improvement in inductor quality.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a spiral patterned ground shield provided in an insulating film over a semiconductor substrate; and
a spiral inductor arranged over the insulating film in the same position as the patterned ground shield.

2. The apparatus of claim 1, wherein the patterned ground shield spirals opposite to a spiral direction of the inductor.

3. The apparatus of claim 2, wherein both ends of the patterned ground shield are connected to ground.

4. The apparatus of claim 1, wherein the patterned ground shield includes a first line pattern which spirals from one side periphery to the center, and a second line pattern which spirals from the center to the other side periphery.

5. The apparatus of claim 4, wherein the patterned ground shield has a closed-loop shape.

6. The apparatus of claim 5, wherein the one end of the first line pattern arranged on the center is connected to one end of the second line pattern arranged on the center.

7. The apparatus of claim 6, wherein the other end of the first line pattern arranged in one side periphery is connected through an additional line pattern to the other end of the second line pattern arranged in the other side periphery.

8. The apparatus of claim 7, wherein the patterned ground shield has a structure wherein the one end of the first line pattern arranged on the center is separated from one end of the second line pattern arranged on the center.

9. The apparatus of claim 8, wherein the patterned ground shield comprises a first closed-loop.

10. The apparatus of claim 8, wherein the first closed-loop is provided by one additional line pattern to connect one end of the first line pattern arranged on the center to the other end of the first line pattern arranged on one side periphery.

11. The apparatus of claim 10, wherein the patterned ground shield includes a second closed-loop.

12. The apparatus of claim 11, wherein the second closed-loop is provided by another additional line pattern to connect one end of the second line pattern arranged on the center to the other end of the second line pattern arranged in the other side periphery.

13. A method comprising:
forming a spiral patterned ground shield in an insulating film over a semiconductor substrate; and
forming a spiral inductor over the insulating film in the same position as the patterned ground shield.

14. The method of claim 13, wherein the formation of the patterned ground shield includes forming a first line pattern which spirals from one side periphery to the center.

15. The method of claim 14, wherein the formation of the patterned ground shield includes:
forming a second line pattern which spirals from the center to the other side periphery,

16. The method of claim 15, wherein one end of the first line pattern arranged on the center is connected to one end of the second line pattern arranged on the center.

17. The method of claim 16, further including:
forming an additional line pattern to connect the other end of the first line pattern arranged in one side periphery to the other end of the second line pattern arranged in the other side periphery.

18. The method of claim 13, wherein the formation of the patterned ground shield is carried out by forming a first line pattern which spirals from one side periphery to the center, and a second line pattern which spirals from the center to the other side periphery, such that one end of the first line pattern arranged on the center is separated from one end of the second line pattern arranged on the center.

19. The method of claim 18, including:
forming one additional line pattern to connect one end of the first line pattern arranged on the center to the other end of the first line pattern arranged on one side periphery.

20. The method of claim 19, including:
forming another additional line pattern to connect one end of the second line pattern arranged in the center to the other end of the second line pattern arranged in the other side periphery.
